(19) United States
(12) Patent Application Publication
(10) Pub. No.: US 2024/0286828 A1
(43) Pub. Date: Aug. 29, 2024

(54) BARRIER ASSEMBLY FOR A CARGO CONTAINER

(71) Applicant: Kinedyne LLC, Prattville, AL (US)

(72) Inventors: Jason Scott LUECK, Prattville, AL (US); Mark Christopher KAJDOS, Prattville, AL (US)

(21) Appl. No.: 18/585,047

(22) Filed: Feb. 22, 2024

Related U.S. Application Data
(60) Provisional application No. 63/447,721, filed on Feb. 23, 2023.

(51) Int. Cl. B65D 90/00

(52) U.S. Cl. CPC B65D 90/0053; B65D 90/0066; B65D 2588/12; B65D 2590/0041

(57) ABSTRACT

This disclosure relates to a barrier assembly that can be selectively secured near an opening of a cargo container and selectively deployable near the opening of the cargo container (e.g., along the rear and/or side of the cargo container) to control access to the space therein and to help secure cargo contained within the space. The barrier assembly can include one or two panels that can permit the barrier assembly to wrap, bend, or flexibly extend around cargo. In at least some examples, at least one panel can be hingedly affixed to a side of the cargo container, such that the panel can rotate between a stowed position and a deployed position. In examples, the panel is also slidably connected to the side of the cargo container, such that a fore-aft position of the panel can be adjusted and customized to the cargo.

### CROSS-REFERENCE TO RELATED APPLICATIONS

This application claims the benefit of U.S. Provisional Application No. 63/447,721 (filed Feb. 23, 2023). The aforementioned application is hereby incorporated by reference in its entirety.

### TECHNICAL FIELD

This disclosure relates to a barrier assembly for at least partially blocking or partitioning a cargo container along with methods for using the same.

### BACKGROUND

Cargo containers (e.g., enclosed trailer, enclosed flatbed, box truck, etc.) typically include one or more openings (e.g., along the side(s) and/or rear) for accessing the enclosed space within the container (e.g., for loading and unloading cargo). In some instances, the opening(s) can include a gate or door that can operate to control access through the opening and/or can help restrain the cargo. Cargo that is loaded within the enclosure can be secured by cargo nets, which can help prevent the movement of goods inside the cargo container, reducing the risk of damage due to shifting loads. Conventional alternatives to cargo nets that serve similar purposes include straps and ratcheting tie-downs, bungee cords, dunnage bags, loading nets, and the like.

### DETAILED DESCRIPTION OF DRAWINGS

The present systems and methods for a barrier assembly for a cargo container are described in detail below with reference to these figures.

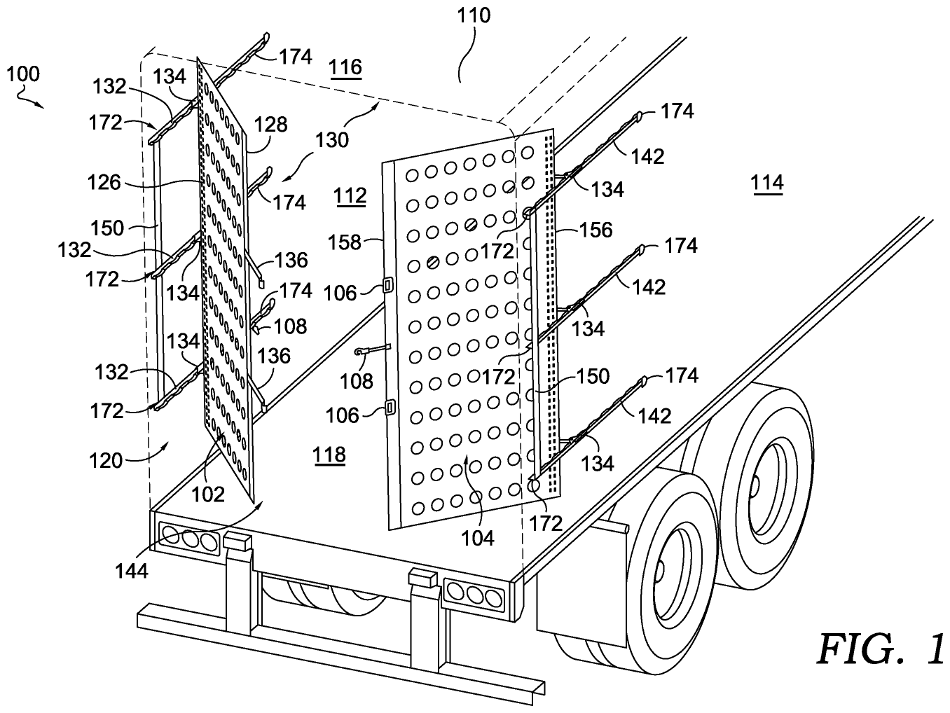

FIG. 1 depicts a barrier assembly with two panels installed near an opening of a cargo enclosure, in accordance with examples of this disclosure.

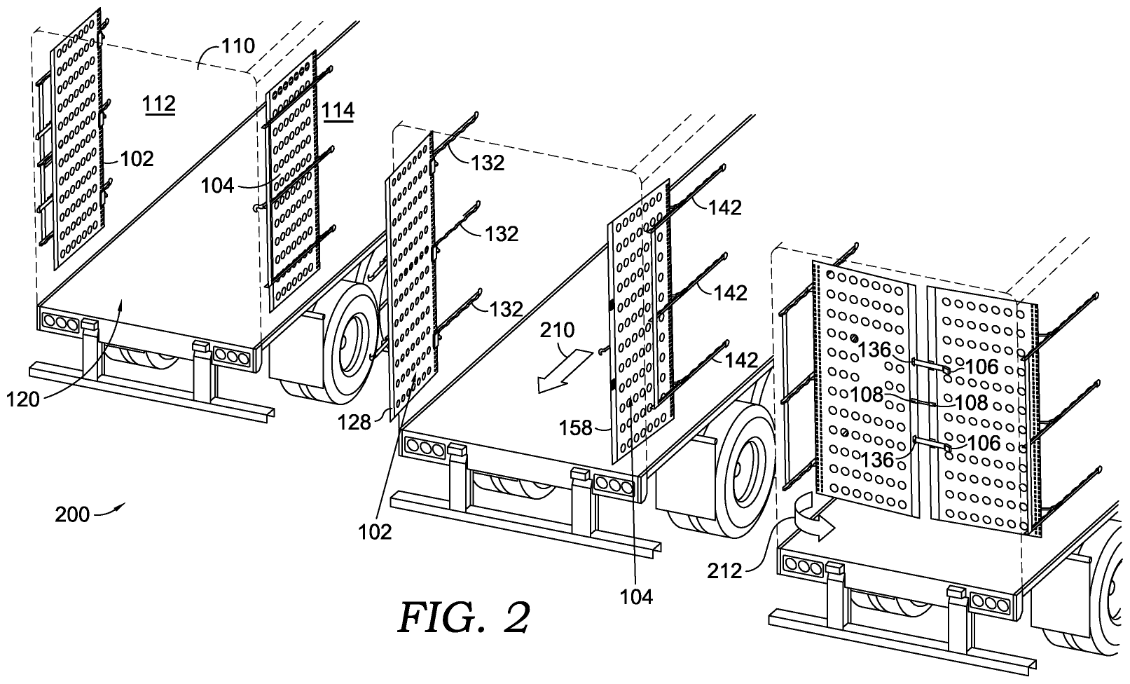

FIG. 2 depicts the barrier assembly with two panels in a series of stages transitioning between a stowed position and a deployed position, in accordance with examples of this disclosure.

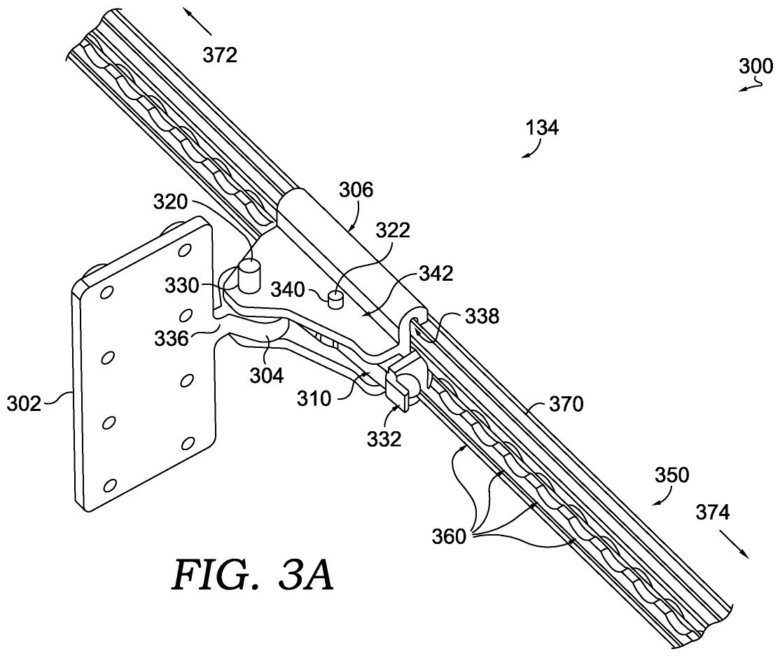

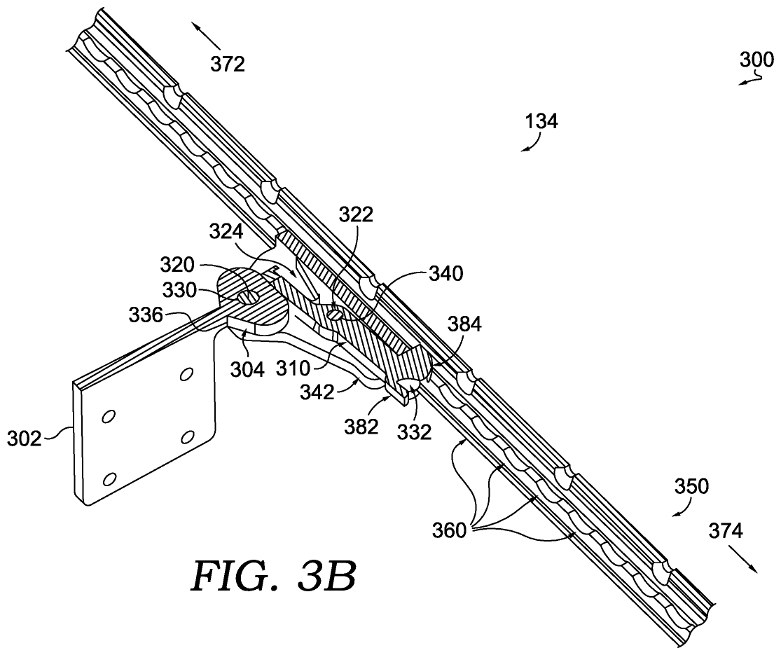

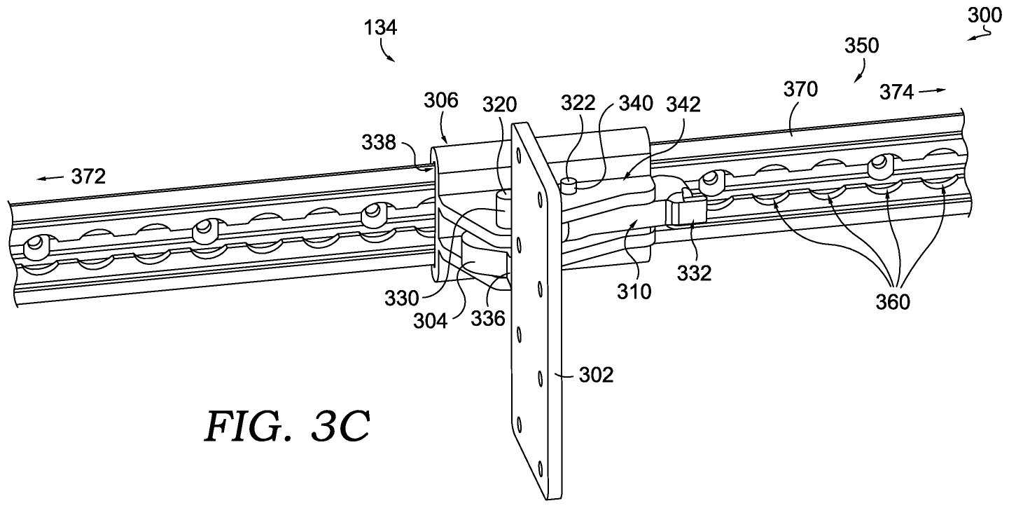

FIG. 3A depicts a hinge of the barrier assembly, in accordance with examples of this disclosure.

FIG. 3B depicts a cross-sectional view of the hinge of the barrier assembly, in accordance with examples of this disclosure.

FIG. 3C depicts a slightly different perspective of the hinge of the barrier assembly, in accordance with examples of this disclosure.

FIG. 3D depicts a cross-sectional view of the slightly different perspective of the hinge of the barrier assembly, in accordance with examples of this disclosure.

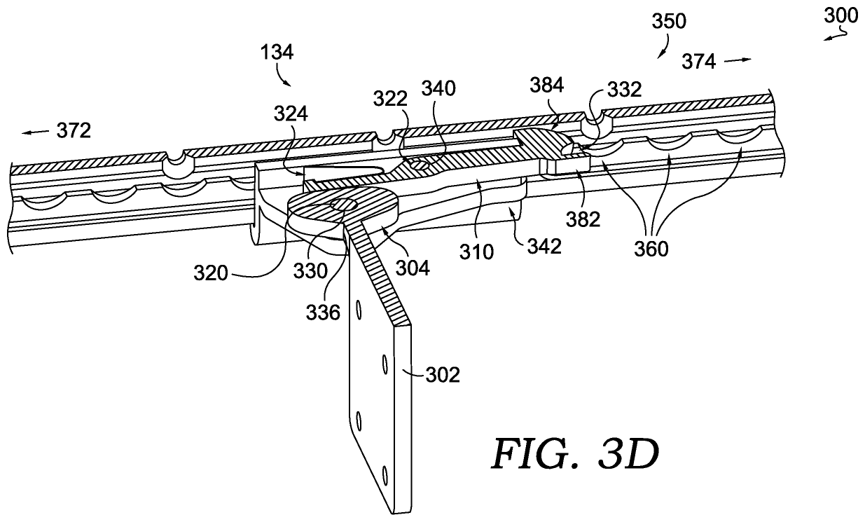

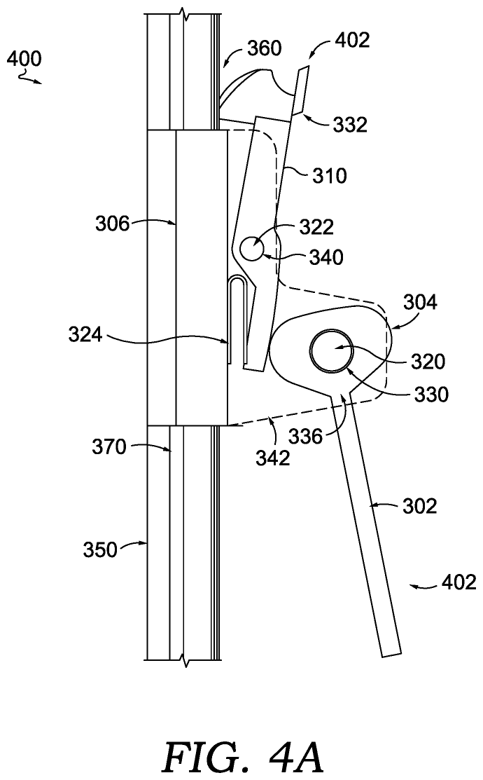

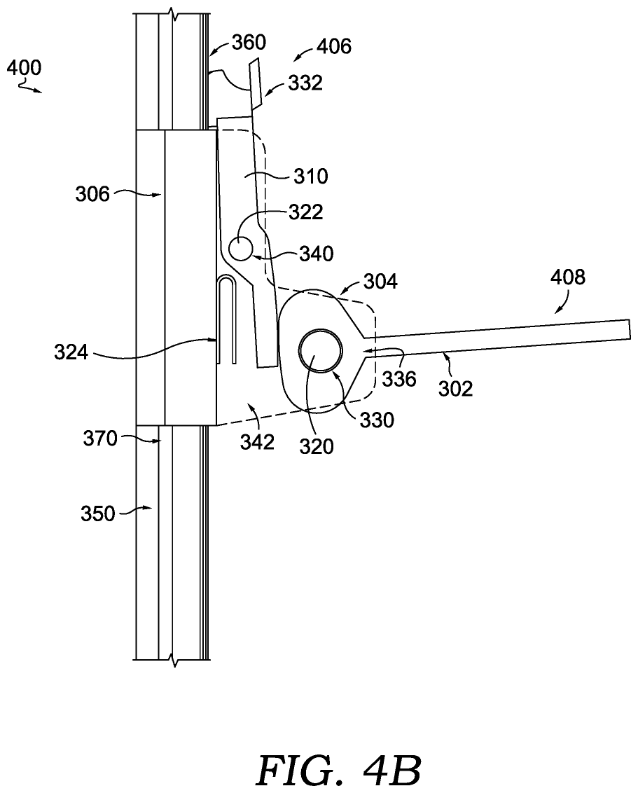

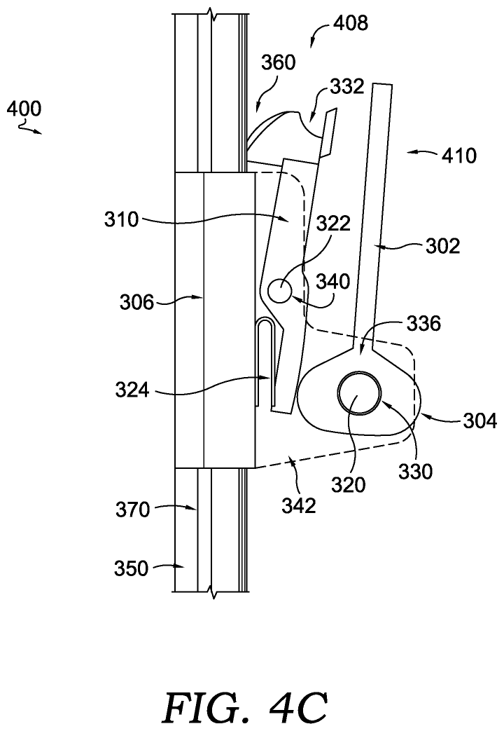

FIG. 4A depicts a side view of the hinge in a first unlocked position, in accordance with examples of this disclosure.

FIG. 4B depicts a side view of the hinge in a locked position, in accordance with examples of this disclosure.

FIG. 4C depicts a side view of the hinge in a second unlocked position, in accordance with examples of this disclosure.

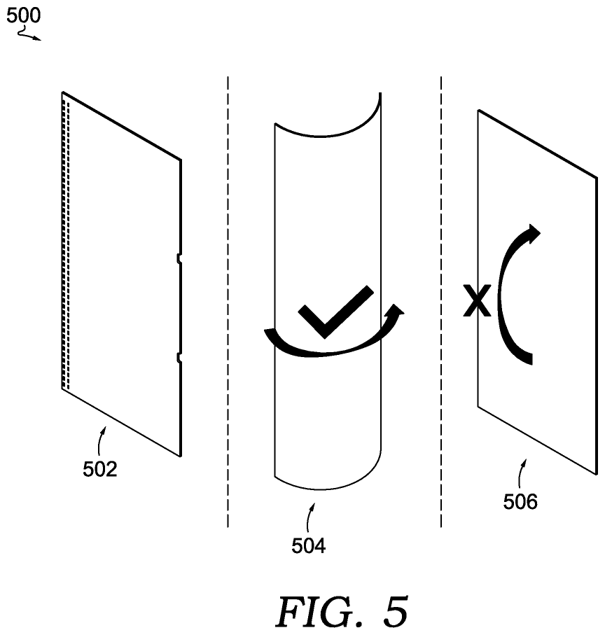

FIG. 5 depicts a flexibility of a panel of the two-panel barrier assembly, in accordance with examples of this disclosure.

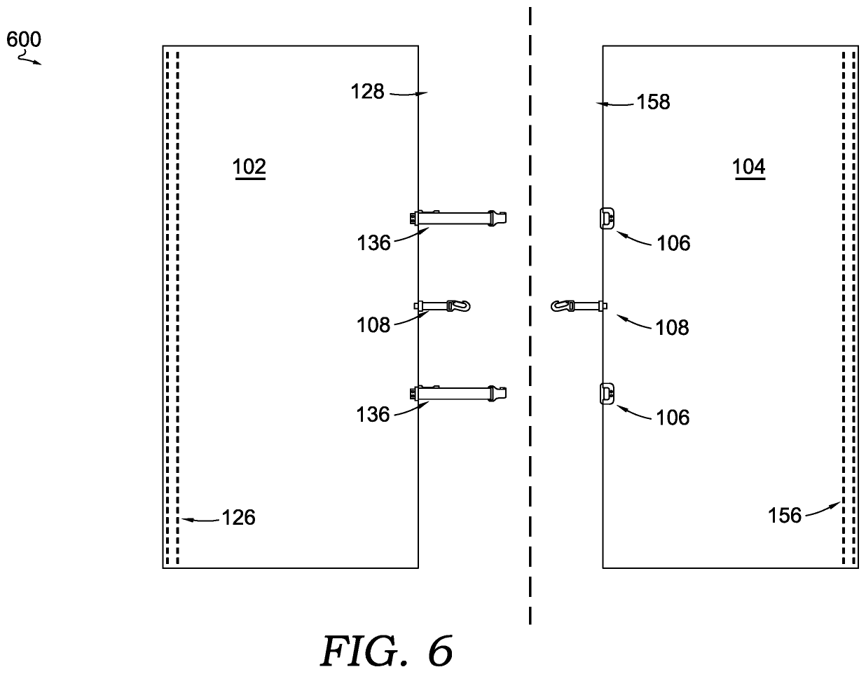

FIG. 6 depicts a first panel and a second panel with respective straps and connection hardware, in accordance with examples of this disclosure.

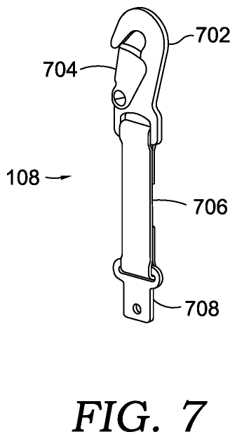

FIG. 7 depicts a front view of a door strap and a back view of the door strap, in accordance with examples of this disclosure.

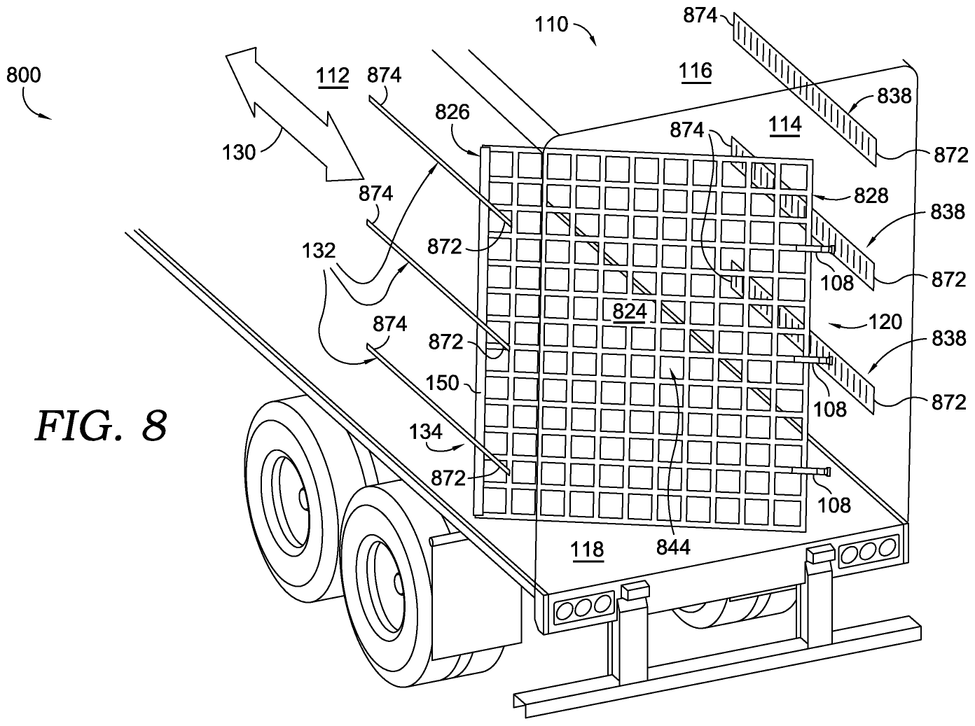

FIG. 8 depicts a barrier assembly with one panel installed near an opening of a cargo enclosure, in accordance with examples of this disclosure.

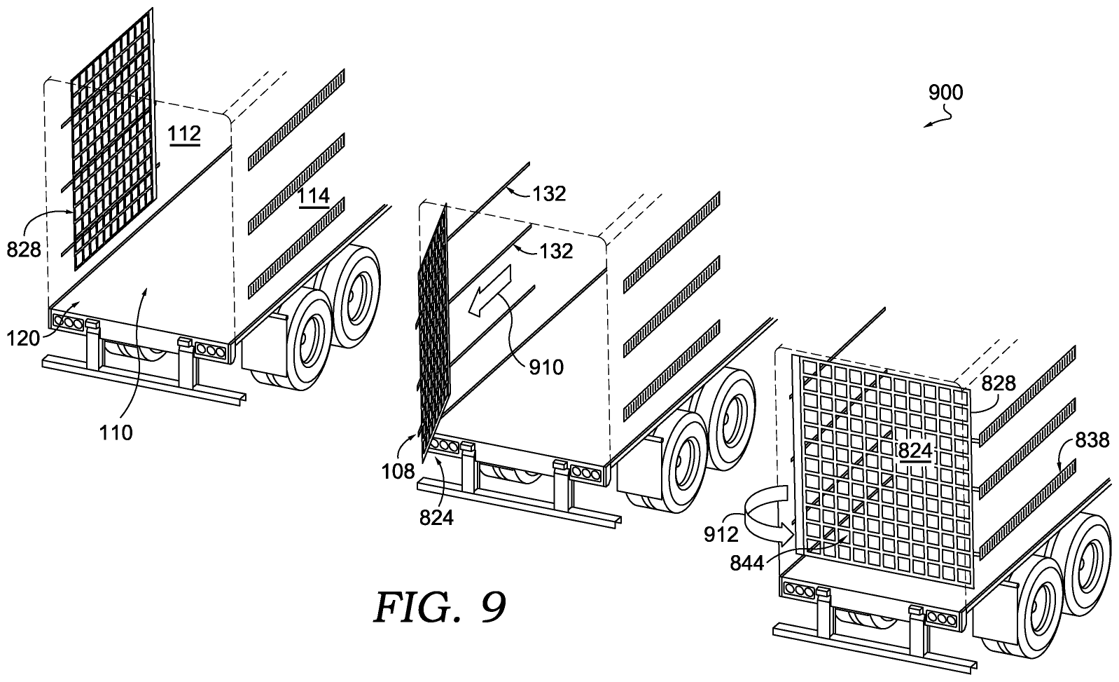

FIG. 9 depicts the barrier assembly with one panel transitioning between a stowed position and a deployed position, in accordance with examples of this disclosure.

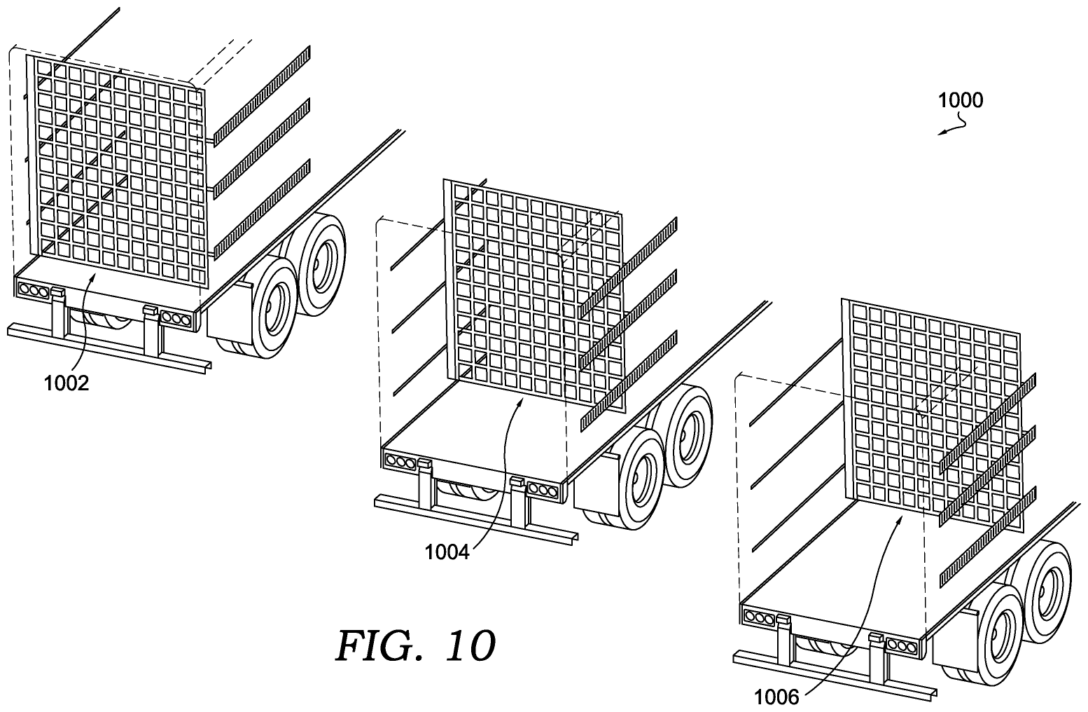

FIG. 10 depicts the barrier assembly with one panel at different fore-aft positions, in accordance with examples of this disclosure.

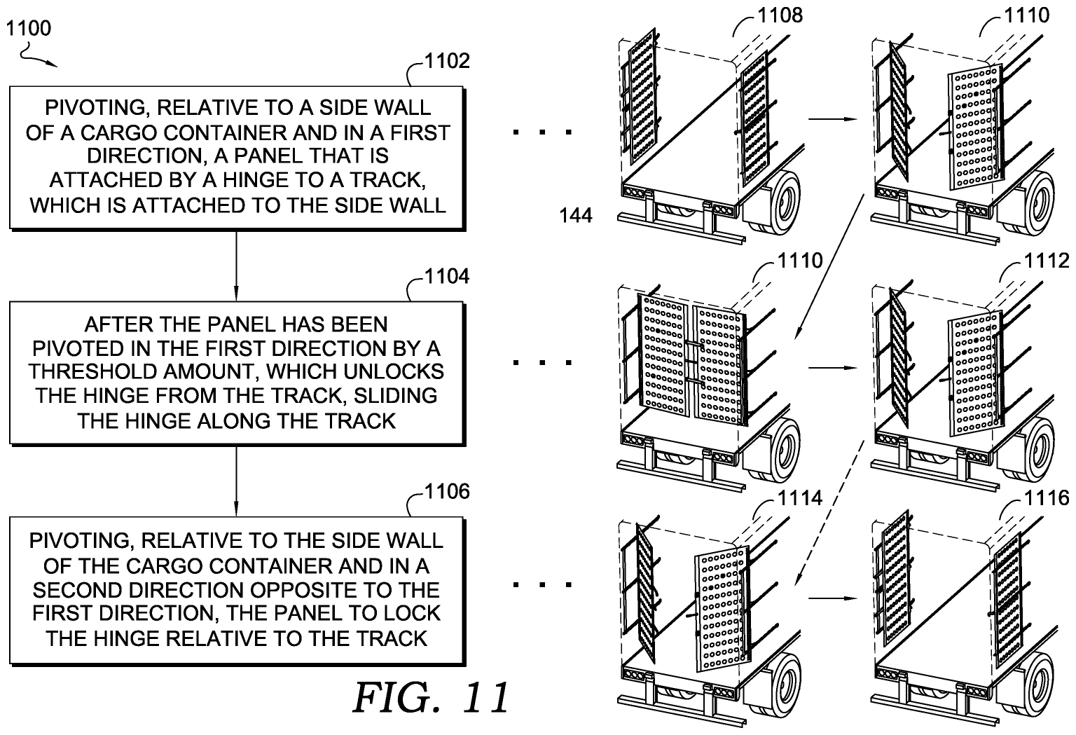

FIG. 11 depicts the barrier assembly in different positions in association with a method for either deploying or stowing the barrier assembly.

### DETAILED DESCRIPTION

This detailed description is related to a barrier assembly for a cargo container or enclosure (e.g., enclosed trailer, enclosed flatbed, box truck with enclosure on vehicle frame, enclosure of a military transport, etc.). In examples, the barrier assembly is selectively deployable near an opening of the cargo container (e.g., along the rear and/or side of the cargo container) to control access to the space therein and to help secure cargo contained within the space. In at least some examples, the barrier assembly includes a panel that at least partially spans across the cargo container (e.g., to block an opening to the cargo container). The panel may be a door-style panel, a solid panel, a rigid panel, a semi-rigid panel, a collapsible panel, or any other suitable panel. Among other things, the nature of the panel can permit the panel to flexibly bend and wrap around cargo of varying sizes and shapes. In addition, the panel can be hingedly affixed to a side of the cargo container, such that the panel can rotate between a stowed position (e.g., positioned flatter up against the wall) and a deployed position. In at least some examples, the panel is also slidably connected to the side of the cargo container, such that a fore-aft position of the panel can be adjusted and customized to the cargo. In some examples, the barrier assembly can include a single panel that spans from one side of the cargo container to an opposing side. In some examples, the barrier assembly can include two panels, each of which attaches to a respective side of the cargo container and releasably connects to the other panel to collectively span across the cargo container.

In contrast to the present invention, conventional solutions used to contain cargo tend to lack the rigidity and strength, as well as the versatility and accessibility, of the current disclosure. For example, conventional cargo nets, straps, and webbing can be stretched across an opening in a cargo container and may be used to secure cargo that is loaded within the enclosure. In some instances, these conventional accessories have fasteners at an end that lock on with logistics, beams, or tracks along an inside wall of a cargo container. However, cargo nets, straps, and webbing can, typically require significant time to both install (e.g., once cargo has been loaded) and disconnect (e.g., for storage when not in use), since each fitting must be manually connected/disconnected. In addition, these conventional accessories can get tangled during storage, and typically require a separate storage location (e.g., once they've been disconnected). Furthermore, once installed, changing the fore-aft position of these conventional accessories requires significant time (e.g., to disconnect each fitting and move to a new position).

In contrast to conventional solutions, the barrier assembly described herein is easily storable and may be robust enough to secure large cargo within a cargo container. In at least some examples, the barrier assembly may be constructed of a semi-rigid, flexible material that can permit the barrier to wrap or flexibly extend around cargo, which is often arranged nonlinearly from one side to the other. In other words, while the material is flexible enough to bend around cargo (e.g., similar to cargo nets), which may be unevenly stowed in the enclosure and/or may press up against the barrier assembly, the panel of the barrier assembly is rigid enough to contain large cargo (e.g., but not as rigid as a truck tailgate, for example). In some embodiments, the barrier assembly is large enough to not only contain large cargo horizontally (e.g., the width of a cargo container), but vertically (e.g., the height of a cargo container), which corrects a fault of cargo nets and the like. For example, while cargo nets often only stretch across a cargo container widthwise, which could leave substantial gaps above and/or below the cargo nets (e.g., cargo located in these gaps may be unsecured), the barrier assembly may span both the width and the height of the cargo container.

In addition, while the barrier assembly may be used to help secure cargo (e.g., reducing the risk of goods being damaged due to shifting loads) within a cargo container, the barrier assembly also provides the ability to control access to the space therein. For example, when the barrier assembly is unlocked, the cargo stored within the cargo container may be accessed, allowing someone to enter therein and manipulate the cargo. In at least some examples, a position of the barrier assembly relative to the opening can be modified or adjusted. For example, where the barrier assembly is used to control access to a rear opening of the rear enclosure (e.g., the back of an enclosed trailer or box truck), the barrier assembly can extend from one side of the enclosure to the other side of the enclosure, and a fore-aft position of the barrier assembly is adjustable. This is in contrast to a conventional rear gate/door or tailgate, which typically includes only a fixed position at the rear end of the rear enclosure. For at least these reasons, the barrier assembly disclosed herein tends to be more versatile than conventional solutions.

Referring now to FIG. 1, subject matter of the present disclosure is related to securing cargo in, and controlling access to, a cargo container. FIG. 1 depicts an example use-case including an on-frame cargo system (e.g., a box truck or other vehicle in which the rear enclosure is secured to the vehicle frame). FIG. 1 depicts a rear enclosure 110 that could be for a trailer, and subject matter of this disclosure could also apply to a rear enclosure in any cargo containment (e.g., examples may include international intermodal containers, enclosed trailers, enclosed flatbeds, box trucks with enclosures on vehicle frames, enclosure of a military transports, etc.). The rear enclosure 110 generally comprises a first side wall 112, a second side wall 114, a roof 116, and a floor 118. In at least some examples, the rear enclosure 110 can include an opening 120 that provides access to an enclosed space for containing and securing cargo.

Examples of the present disclosure may include a barrier assembly. In some examples, the barrier assembly can include a single panel, such as single-panel barrier assembly 844 (e.g., briefly referring to FIGS. 8-10), that spans from one side of the cargo container to an opposing side. In some examples, the barrier assembly can include two panels, such as two-panel barrier assembly 144, each of which attaches to a respective side of the cargo container and releasably connects to the other panel to collectively span across the cargo container.

The two-panel barrier assembly 144 may be arranged near the opening 120. In at least some examples, the two-panel barrier assembly 144 may include two rectangular panels (e.g., first panel 102 and second panel 104). In some examples, referring briefly now to FIGS. 8-10, the barrier assembly may include one rectangular panel (e.g., depicted as semi-rigid webbing, but could be in other forms).

In at least some examples, the panel (e.g., either the first panel 102 and/or the second panel 104 of the two-panel barrier assembly 144, or the panel 824 of the single-panel barrier assembly 844) are hingedly and slidably connected to a wall. The panel can take on several forms and may be constructed from different material. For example, the panel can be constructed out of rigid materials and/or semi-rigid materials.

Panels with semi-rigid material properties, for instance, may be flexible enough to bend or curve around cargo (not pictured), and also rigid enough to retain its shape or form under its own weight. As such, the semi-rigid material properties may allow a panel, when not under an external load (e.g., attached to a side wall of the cargo container), to hold its shape (e.g., by remaining relatively planar and upright). Furthermore, in at least some examples, when a load is applied to the panel of the semi-rigid material, the panel can bend around the load and return to its shape when the load is removed. For example, the semi-rigid material may be a composite polymer material constructed from thermoplastic resin and fiberglass, but the material may be any composite material with flexibility and rigidity of the present disclosure. In other words, the semi-rigid material may be any composite, manufactured, and/or synthetic material with the semi-rigid material properties.

Furthermore, in some embodiments, the panels may be constructed from a rigid material (e.g., metal, fiber glass, hard plastic, wood, etc.). Panels constructed from rigid materials, for instance, may have rigid material properties and may take on several forms (e.g. telescoping, foldable, accordion style, etc.). In some examples, rigid material properties allow the panel to contain cargo without precisely conforming to the exact shape or contours of the cargo. For example, panels constructed out of rigid material may be configured as telescoping doors that slide along the rear enclosure of cargo containment, but are still hingedly and slidably connected to a wall. In another example, the rigid panels may include a series of foldable slats (e.g., six-inch wooden slats, for example) that are hingedly connected and allow the panels to fold open or closed. For example, a panel can itself have multiple sub-panels (e.g., slats) that connect to one another (e.g., via hinges, such as piano hinges or similar hinges) to form a larger panel that is bendable, collapsible, and/or flexible. In yet another example of a panel with rigid material properties, the panel may extend from a wall of the rear enclosure like an accordion and connect either to another panel or to the opposite side wall to contain cargo within the rear enclosure. Furthermore, if the panel is constructed from rigid material properties, the panel may retain its shape under its own weight and the structure of the panel (e.g., telescoping, folding, or accordion) may allow the panel to be manipulated around cargo. Notably, according to aspects of the present disclosure, the panels may be constructed from either rigid material and/or semi-rigid materials.

Additionally or alternatively, the panels may be solid (e.g., as depicted in FIGS. 5 and 6), have circular holes (e.g., as depicted in FIGS. 1, 2, and 11), have square holes (e.g., as depicted in FIGS. 8, 9, and 10), or any other configuration that allows the panels to have semi-rigid material properties and/or rigid material properties. In at least some examples, the thickness of the panels may be in a range of about 0.04 inches to about 0.1 inches. These are just example thickness dimensions, and in other examples, the panel(s) can be thinner than 0.4 inches or thicker than 0.1 inches.

In some examples, a first panel 102 and a second panel 104 may be configured to hinge relative to a respective side wall, move fore-aft relative to the side wall, and interlock together. For example, the first panel 102 may include a first side edge 126 and a second side edge 128. Additionally, the second panel may also include a first side edge 156 and a second side edge 158. In at least some examples, the first side edge 126 of first panel 102 may include at least one connector that is configured to connect the first panel 102 to the first side wall 112. Also, in at least some examples, the first side edge 156 of second panel 104 may include at least one connector that is configured to connect the second panel 104 to the second side wall 114. In addition, in some embodiments, the connector can include a hinge connection, such as hinge 134, or other types of connectors that permit the first panel 102 and the second panel 104 to pivot, hinge, or otherwise rotate relative to the first side wall 112 and the second side wall 114, respectively.

In some examples, the first side edge 126 of first panel 102 can include hardware configured to permit the first panel 102 to move fore-aft 130, and the first side edge 156 of second panel 104 can also include hardware configured to permit the second panel 104 to move fore-aft 130. For example, the two-panel barrier assembly 144 can include a first set of one or more tracks 132 secured to first side wall 112, and the two-panel barrier assembly 144 can also include a second set of one or more tracks 142 secured to second side wall 114. Both the first set of one or more tracks 132 and the second set of one or more tracks 142 comprise a first terminal end 172 and a second terminal end 174. That is, each track in the set of tracks can include a respective forward end and a respective rearward end (closest to the opening). In at least some embodiments, the first set of one or more tracks 132 and the second set of one or more tracks 142 are secured to the first side wall 112 and the second side wall 114, respectively. In some examples, a track mount 150 may be used to ensure the tracks are aligned and spaced apart by some distance. For example, the first set of one or more tracks 132 and the second set of one or more tracks 142 may be secured to the first side wall 112 and the second side wall 114, respectively, through the track mount 150 (e.g., track mount 150 may serve as a template to facilitate proper installation of the tracks).

Furthermore, the first side edge 126 of first panel 102 can include hardware configured to slide or roll along the tracks 132, and the first side edge 156 of second panel 104 can include hardware configured to slide or roll along the tracks 142. In some examples, the first side edge 126 of first panel 102 and the first side edge 156 of second panel 104 can include one or more hinges 134 that are configured to enable both the first panel 102 and the second panel 104 to hinge relative to the first side wall 112 and the second side wall 114, respectively, as well as move fore-aft along the first set of one or more tracks 132 and the second set of one or more tracks 142, respectively.

In some examples, the second side edge 128 of first panel 102 and the second side edge 158 of second panel 104 may include one or more fasteners to attach the first panel 102 to the second panel 104. For example, the first panel 102 may include one or more main straps 136 that are configured to attach to one or more main strap anchors 106 that are located on the second panel 104. In at least some examples, the main strap anchors 106 can be slots, holes, apertures, grooves, protrusions, or any other structure that can receive a strap and lock the strap in place. The main straps 136 can, in some instances, include hardware, fasteners, or connectors (e.g., slot fitting, hook, tab, etc.) configured to mate with the main strap anchors 106 (e.g., engage with mounting recesses or slots on the main strap anchors 136). Therefore, in some examples, the first panel 102 and the second panel 104 can be secured (e.g., near a longitudinal midline of the rear enclosure) to one another (e.g., via a flexible strap connection) to span the distance between the first side wall 112 and the second side wall 114. In addition, in some examples, the main straps 136 can include an adjustable length, such as via a buckle that permits a length of the strap to be paid out or taken up. An adjustable length can be used to customize the barrier based on the size and shape of the cargo. In addition, the adjustable length can be used to allow the two-panel barrier assembly 144 to accommodate and/or fit rear enclosures having different widths.

In some examples, a door strap 108 can be located on both the first panel 102 and the second panel 104. The door straps 108, for example, may include a connector that allows the door straps 108 to attach to one another. Furthermore, in at least some examples, when the two-panel barrier assembly 144 is not securing cargo, the door strap 108 on the first panel 102 can be used to secure the first panel 102 to the first side wall 112, and the door strap 108 on the second panel 104 can also be used to secure the second panel 104 to the second side wall 114 (e.g., representing the two-panel barrier assembly 144 being in a stowed position). In other words, in some examples, the second side edge 128 of first panel 102 can be secured (e.g., via the door straps 108) to the first side wall 112 to retain the two-panel barrier assembly 144 against the first side wall 112, and the second side edge 158 of second panel 104 can be secured to the second side wall 114 to maintain the two-panel barrier assembly 144 in a stowed position. In addition, in some examples, the door straps 108 can also include an adjustable length, such as via a buckle that permits a length of the strap to be paid out or taken up.

Referring to FIG. 2, a series of depictions illustrate the two-panel barrier assembly 144 moving from a stowed position to a deployed position. For example, in the stowed position, the two-panel barrier assembly 144 can be arranged relatively flush against both the first side wall 112 and the second side wall 114, in a position that is out of the way of the opening 120 and permits easy loading/unloading and ingress/egress. In some examples, when ready to deploy the two-panel barrier assembly 144, the first panel 102 can be slid along the tracks 132 to a desired position (e.g., as indicated by arrow 210); the second panel 104 can be slid along the tracks 142 to a desired position; the first panel 102 and the second panel 104 can be rotated or hinged to a closed position (e.g., as indicated by arrow 212); and the main straps 136 can be secured to the main strap anchors 106 when the two-panel barrier assembly 144 is in a desired mounting position along the tracks 132 and 142.

Referring to FIG. 3A, the hinge 134 may be couple to either the first panel 102 or the second panel 104 of the two-panel barrier assembly 144 or to the panel 824 of the single-barrier assembly 844. In at least some examples, the hinge 134 can operate to permit a panel to rotate relative to a side wall and to slide along a track 350 to adjust a fore-aft position.

The hinge 134 can include a first hinge plate 302. In examples, the first hinge plate 302 may be affixable to any suitable panel of either the two-panel barrier assembly 144 or the single-panel assembly 844. The first hinge plate 302 may also include a knuckle 336, which may protrude from the hinge plate 302. In some examples, the knuckle 336 may include a camming surface 304 (e.g., an ovular or complex curve). Furthermore, in some examples, a first through hole 330 extending through the knuckle 226 may receive a first pivot pin 320, which rotatably or pivotably connects the knuckle 336 and the first hinge plate 302 to other parts of the hinge 134.

In examples, when the first pivot pin 320 is inserted into the through hole 330, the knuckle 336 of the first hinge plate 302 may be pivotably connected to a second hinge plate 342 of a slider bracket 306. In at least some examples, the track 350 may be any one of the first set of one or more tracks 132 secured to the first side wall 112 or any one of the second set of one or more tracks 142 secured to the second side wall 114. In at least some examples, the second hinge plate 342 may include two plates that are spaced apart and that extend from the web of the slider bracket 306 (e.g., the web that forms the channel that mates with the track 350).

In at least some examples, the slide bracket 306 comprises a channel 338 (e.g., a c-channel) with web having an outer face that faces towards the second hinge plate 342 and an inner face that is oriented towards the track 350. In examples, the slider bracket 306 is configured to slide along the track 350 among any positions between a first terminal end 372 (e.g., closer to the respective rearward end, closer to the opening 120 of the cargo container) and a second terminal end 374 (e.g., closer to the respective forward end) of the track 350. For example, the track 350 may extend through the channel 338 of the slider bracket 306, allowing the slider bracket 306 of hinge 134 to engage and slide along a rail 370 of the track 350. In examples, a second through hole 340 may receive a second pivot pin 322 that may extend through the second hinge plate 342 and through a pawl 310 (e.g., housed in the space between the plates of the second hinge plate 342). In examples, when the second pivot pin 322 is inserted into the through hole 340, the pawl 310 may be pivotably connected to the second hinge plate 342. For example, the pawl 310 may be secured into a position between both plates of the second hinge plate 342 that allows the pawl 310 to pivot while positioned between both plates of the second hinge plate 342. In at least some examples, the pawl 310 may include the head 332 that is configured to engage recesses of the track 350.

Referring now to FIG. 3B, FIG. 3B is a cross-section image of the hinge 134. In examples, the hinge 134 may include a spring 324 that is housed between the two plates of the second hinge plate 342 and that engages with the pawl 310. Additionally or alternatively, FIGS. 3C and 3D illustrate some of the elements in FIGS. 3A and 3B, but from a slightly different perspective.

As shown in FIG. 4A, the camming surface 304 of the knuckle 336 may push on one end of the pawl 310 (e.g., the end opposite of the head 332). In some examples, the knuckle 336 pivots between the second hinge plates 342 about an axis located at the center of the first pivot pin 320. For example, when the first hinge plate 302 is rotated to a first plate position 404, the camming surface 304 pushes on the end of the pawl 310, which pushes the pawl 310 onto the spring 324, which (e.g., like a teeter totter) causes the pawl 310 to pivot about an axis located at the center of the second pivot pin 322, disengaging the head 332 of the pawl 310 from a recess 360 located within the track 350. In other words, for example, when the first hinge plate 302 is in the first plate position 404, the pawl 310 is in the first pawl position 402, which is a position indicating that the pawl 310 is not engaged with the recess 360 and, thus, indicating that the hinge 134 is not locked into a recess 360 of the track 350.

With reference now to FIG. 4B, FIG. 4B depicts the hinge 134 when the barrier assembly (e.g., either two-panel barrier assembly 144 or single-panel barrier assembly 844) is in a locked position and attached at some point (e.g., the recess 360) on the track 350. In at least some examples, when the first hinge plate 302 is rotated (e.g., via the knuckle 336 pivoting about an axis located at the center of the first pivot pin 320) to a second plate position 408, the complex curve of the camming surface 304 of the knuckle 336 pushes the pawl 310 into the spring 324, the spring 324 pushes back on the pawl 310, and the push back from the spring 324 causes the head 332 of pawl 310 (e.g., via the pawl 310 rotating about an axis located at the center of second pivot pin 322) to engage with the recess 360 of the track 350. In other words, rotating the first hinge plate 302 to a position that is perpendicular (e.g., 90 degrees) to the track 350 (e.g., the second plate position 408) causes the head 332 of pawl 310 to interlock the hinge 134 with the track 350. In at least some examples, the hinge 134 locks in place when the first hinge plate 302 is in a position that is between 55 and 140 degrees in relation to a longitudinal orientation of the track 350. For example, when the first hinge plate 302 is in a position that is not between 55 and 140 degrees in relation to the track 350 (e.g., the first plate position 404, a position greater than 140 degrees, as illustrated in FIG. 4A), the hinge 134 is in an unlocked position.

Referring back now to FIG. 3B, the hinge 134 of a deployed barrier assembly (e.g., the two-panel barrier assembly 144 or the single-panel barrier assembly 844) may be in a locked position (e.g., such as the second plate position 408). In examples, the head 332 of pawl 310 is inserted into a recess 360 when a panel of the barrier assembly (e.g., the first panel 102 or the second panel 104 of the two-panel barrier assembly 144, or the panel 824 of the single-panel barrier assembly 844) is in a position between 55 and 140 degrees relative to the track 350.

When in such a position, for example the hinge 134 is locked in place (e.g., at a position along the track 350). For instance, being locked in this position means that the hinge 134 is not movable along the track absent some external force, but rather in a deployed position and ready to be secured across cargo located within an enclosure of a cargo container. When in such a position, the hinge may be manually unlocked by physically lifting the head 332 of the pawl 310 by pulling outward on a head lip 382 of the pawl 310 (e.g., away from the track), thereby releasing the head 332 of the pawl 310 from the recess 360. In at least some examples, a head curve 384 of the head 332 of the pawl 310 allows the barrier assembly, even when in a locked position, to be pushed forward (e.g., away from the opening 120 of the cargo container) and in the direction of the second terminal end 374 but not backward (e.g., towards the opening 120 of the cargo container). As such, when in a locked position the barrier assembly may be pushed forward, and head curve 384 allows the head 332 of the pawl 310 to glide out of the recess 360 and engage the next recess 360 (e.g., up to two or three recesses 360 beyond the recess wherein the barrier assembly was originally in a locked position). This allows operators to make final positioning adjustments to the barrier assembly (e.g. pushing it up against cargo) even after the panels (e.g., the first panel 102 and the second panel 104) have been secured together in the locked position.

As shown in FIG. 4C, additionally or alternatively, the hinge 134 can be released from a locked position on the track 350 by moving the first hinge plate 302 to a third plate position 412 (e.g., a position less than 55 degrees). In at least some examples, the camming surface 304 of knuckle 336 may push on the end of the pawl 310 that is opposite of the head 332. In examples, the knuckle 336 pivots about an axis located at the center of the first pivot pin 320. For example, when the first hinge plate 302 is rotated to the third plate position 412, the camming surface 304 pushes on the end of the pawl 310, which pushes the pawl 310 onto the spring 324, which causes the pawl 310 to pivot about an axis located at the center of the second pivot pin 322, disengaging the head 332 of pawl 310 from the recess 360 located within the track 350. In other words, for example, when the first hinge plate 302 is in the third plate position 412 (e.g., a position not between 55 and 140 degrees), the pawl 310 is in the third pawl position 410, which is a position indicating that the pawl 310 is not engaged with the recess 360 and, thus, indicating that the hinge 134 is not locked into a recess 360 of the track 350.

In at least some examples, when the hinge 134 is in an unlocked position along the track 350, the barrier assembly (e.g., two-panel barrier assembly 144 or single-panel barrier assembly 844) can be readably movable and/or stowed. For example, the track 350 may include the rail 370 for the hinge 134 to slide along when transitioning among a plurality of hinge positions along the track 350. In examples, when the pawl 310 is not engaged in a recess 360 of the track 350 (e.g., the first hinge plate 302 is in a position not between 55 and 140 degrees), the hinge 134 may be readily moveable along the tack 350 (e.g., for example, as illustrated by FIGS. 2, 9 and 10), because the slider bracket 306 may slide along the rail 370 anywhere between the terminal ends (e.g., the first terminal end 372 and the second terminal end 374, as illustrated in FIGS. 3A and 3B) of the track 350. Furthermore, when the hinge 134 is in an unlocked position along the rack 350, for example, the barrier assembly can lay flat on an inner wall (e.g., such as the first side wall 112 or the second side wall 114) of the cargo container. In examples, when the barrier assembly is flat against an inner wall, the barrier assembly is in a stowed position (e.g., as illustrated by the left image of the two-panel barrier assembly 144 in FIG. 2 and the left image of the single-panel barrier assembly 844 in FIG. 9).

Referring now to FIG. 5, FIG. 5 depicts the flexible nature of a semi-rigid panel (e.g., either first panel 102 or second panel 104) of the two-panel barrier assembly 144. For example, in a first state 502, the panel (e.g., made of semi-rigid material) is not under an external load (e.g., attached to a side wall of the cargo container). For instance, the first state 502 depicts the panel holding its substantially planar shape. In at least some examples, when a load is applied to the panel of the semi-rigid material (e.g., when the panel is manipulated flushly against cargo), the panel can bend around the load, such as in a second state 504. As depicted by the example illustration of the second state 504, the panel is capable of bending around the vertical axis. This flexible nature (e.g., as depicted in the second state 504), allows the panel to hold the cargo in place without damaging the cargo (e.g., unlike an ultra-rigid panel, which could damage cargo due to an inflexible nature). Furthermore, in at least some examples, the top of the panel could be pushed back (e.g., when in a locked position, the barrier assembly may be pushed back, and head curve 384 allows the head 332 of the pawl 310 to glide out of a recess 360 of a track 350 closer to the roof 116 and engage the next recess 360 of the track 350) so that the panel could more snuggly secure the cargo. That being said, however, the top of the panel can only be pushed back so far (e.g., two to three additional recess positions), because the panel does not bend much about the horizontal access, as depicted in a third state 506. Nevertheless, the tighter that the barrier assembly is secured around the freight, the freight may be better secured.

With reference now to FIG. 6, FIG. 6 illustrates the first panel 102 and the second panel 104 of a two-panel barrier assembly 144 that are in a deployed position (e.g., with respective hinges potentially locked relative to the tracks), ready to be attached to one another, and ready to secure cargo within a cargo container. In at least some examples, the second side edge 128 of the first panel 102 is designed to mate, via at least one main strap 136 and/or at least one door strap 108, with the second side edge 158 of the second panel 104. In other words, in examples, the male connectors of the first panel 102 (e.g., the main straps 136) are designed to engage with female connectors on the second panel 104 (e.g., the main strap anchors 106). In at least some examples, the female connectors (e.g., the main strap anchors 106) can be slots, holes, apertures, grooves, protrusions, or any other structure that can receive a strap and lock the strap in place. The male connectors (e.g., the main straps 136) may, in some instances, include hardware, fasteners, slot fittings, hooks, tabs, or anything configured to mate with the female connectors (e.g., engage with mounting recesses or slots on the main strap anchors 136).

Therefore, in some examples, the first panel 102 and the second panel 104 can be secured (e.g., near a longitudinal midline of the rear enclosure) to one another (e.g., via a flexible strap connection) to span the distance between the first side wall 112 and the second side wall 114 (e.g., the right illustration in FIG. 2). In addition, in some examples, the main straps 136 can include an adjustable length, such as via a buckle that permits a length of the strap to be paid out or taken up. In at least some embodiments, at least one door strap 108, which is also adjustable in length, may latch on to another door strap 108 and attach the first panel 102 to the second panel 104. An adjustable length can be used to customize the two-panel barrier assembly 144 based on the size and shape of the cargo. In addition, the adjustable length can be used to allow the two-panel barrier assembly 144 to accommodate and/or fit rear enclosures of cargo containers having different widths. In examples, when the male connectors of the first panel 102 mate with the female connectors of the second pane 104, the two-panel barrier assembly 144 is in a deployed position, and cargo secured within the cargo container may be secured.

When the barrier assembly (e.g., either the two-panel barrier assembly 144 or the single-panel barrier assembly 844) is released from a deployed position, the barrier assembly may be placed in a stowed positon (e.g., as illustrated by the left image of the two-panel barrier assembly 144 in FIG. 2 and the left image of single-panel barrier assembly 844 in FIG. 9). Referring now to FIG. 7, FIG. 7 depicts the door strap 108, which may lock the panel(s) of the barrier assembly (e.g., the doors of the barrier assembly) to the side wall(s) of the cargo container (e.g., the first side wall 112 and/or the second side wall 114). Notably, the door strap 108 may take on many different forms, and there may be any number of door straps 108 included in the barrier assembly. In other words, the door strap 108 may be any means to lock into a recess (e.g., such as the main strap anchor 106 or any other recess, for example). As such, the main strap 108 need not include a hook and/or a strap. For example, the door strap 108 could be a fastener that hooks on to a wall. Regardless of the construction of the door strap 108, when the door strap 108 is engaged, it may either help keep the barrier system in a deployed position or in a stowed position.

In at least some examples, the door strap 108 comprises an anchor hook 702, a keeper 704, a strap 706, and a mounting plate 708. In some examples, the mounting plate 708 may be used to attach the door strap 108 to a panel (e.g., the first panel 102 or the second panel 104 of the two-panel barrier assembly 144, or the panel 824 of the single-panel barrier assembly 844) of the barrier assembly. In examples, when the barrier assembly is ready to be stowed (e.g., flush against the first side wall 112 and/or the second side wall 114), the anchor hook 702 may connect to an anchor (not pictured) that is attached to a wall (e.g., either the first side wall 112 or the second side wall 114) or connect to the wall itself. In some examples, the keeper 704, via pivotable means, may be pushed in; the anchor hook 702 may hook on to an anchor on a wall or the wall itself; and the keeper 704 may retract to its original position, locking the door strap 108 to the anchor on the wall or the wall itself. It at least some examples, when the door strap 108 is locked onto an anchor on the wall or the wall itself, the barrier assembly is locked in a stowed position. In examples, the length of door strap 108 may be adjusted by lengthening or shortening the strap 706. In order to release the barrier assembly from a stowed position, for example, unhook the door strap 108 from the wall or the wall itself. In examples, once the barrier assembly is released from a stowed position, it may be transitioned into a deployed position.

Referring now to FIG. 8, FIG. 8 depicts a single-panel barrier assembly 844 that spans from one side of the cargo container (e.g., the first side wall 112) to an opposing side (e.g., the second side wall 114). Examples of the present disclosure can include the single-panel barrier assembly 844 that can be arranged near the opening 120 and can be configured to extend from the first side wall 112 of the rear enclosure 110 to the second side wall 114 of the rear enclosure 110. In at least some examples, the single-panel barrier assembly 844 can include a rectangular panel 824 of either rigid and/or semi-rigid material properties (e.g., a semi-rigid material that is more rigid than the semi-rigid material used in the two-panel barrier assembly 144). For example, the semi-rigid material properties can be flexible enough to allow the panel 824 to bend or curve around cargo, and also rigid enough to retain its shape or form under its own weight. Furthermore, if the panel is constructed from rigid material properties, the panel 824 may retain its shape under its own weight and the structure of the panel (e.g., telescoping, folding, or accordion) may allow the panel 824 to be manipulated around the cargo. Furthermore, to help conceptualize the single-panel barrier assembly 844, for example, a width (e.g., from left to right) of either the first panel 102 or the second panel 104 could be elongated, such that either first panel 102 or second panel 104 might extend entirely from the first side wall 112 towards the second side wall 114. As such, the panel 824 could be attached to the second wall 114 (e.g., via a flexible strap connection) to span the distance between the first side wall 112 and the second side wall 114.

The panel 824 can include a first side edge 826 and a second side edge 828. In at last some examples, the first side edge 826 can include a connector, such as the hinge 134, which is configured to connect the panel 824 to the first side wall 112. In addition, in some embodiments, the connector can include a hinge connection, such as the hinge 134, or other types of connectors that permit the panel 824 to pivot, hinge, or otherwise rotate relative to the first side wall 112 and the second side wall 114, respectively. In some examples, the first side edge 826 can include hardware configured to permit the panel 824 to move fore-aft 130. For example, the single-panel barrier assembly 844 can include a first set of one or more tracks 132 secured to the first side wall 112. As such, the first side edge 126 can include hardware configured to slide or roll along the tracks 132, such as the hinge 134. In some examples, the first side edge 126 can include one or more sliding hinges 134 that are configured to enable the panel 824 to both hinge relative to the first side wall 112 and move fore-aft along the tracks 132.

In some examples, the second side edge 828 can include a series of one or more door straps 108 that are configured to attach to the second side wall 114. Alternatively, the second side edge 828 can include a series of one or more main straps 136 (or a combination of door straps 108 and main straps 136) that are configured to attach to the second side wall 114. For example, the second side wall 114 can include a third set of one or more tracks 838 (e.g., logistics track), and each of the tracks 838 can include a series of mounting positions (e.g., slots, holes, apertures, grooves, protrusions, etc.) arranged at different positions in the fore-aft orientation. The door straps 108 (or the main straps 136) can, in some instances, include hardware, fasteners, or connectors (e.g., slot fitting, hook, tab, etc.) configured to mate with the tracks 838 (e.g., engage with mounting recesses or slots on the tracks 838).

In some examples, the door straps 108 can include an adjustable length, such as via a buckle that permits a length of the strap to be paid out or taken up. Furthermore, in some examples, the main straps 136 can also include an adjustable length. An adjustable length can be used to customize the barrier based on the size and shape of the cargo. In addition, the adjustable length can be used to allow the single-panel barrier assembly 844 to accommodate and/or fit rear enclosures having different widths.

Referring to FIG. 9, a series of depictions illustrate the single-panel barrier assembly 844 moving from a stowed position to a deployed position. For example, in the stowed position, the single-panel barrier assembly 844 can be arranged relatively flush, against the first side wall 112 and out of the way of the opening 120 to permit easy loading/unloading an ingress/egress. In some examples, the second side edge 828 can be secured (e.g., via either the main straps 136 or the door straps 108) to the first side wall 112 to retain the single-panel barrier assembly 844 against the first side wall 112. In examples, when ready to deploy the single-panel barrier assembly 844, the panel 824 can be slid along the tracks 132 to a desired position (e.g., as indicated by arrow 910); the panel 824 can be rotated or hinged to a closed position (e.g., as indicated by arrow 912); and the main straps 136 or the door straps 108 can be secured in a desired mounting position along the tracks 838.

As described above, the fore-aft position of the two-panel barrier assembly 144 is customizable, based on the tracks 132 and 142. For example, referring now to FIG. 10, FIG. 10 depicts various fore-aft positions at which the single-panel barrier assembly 844 can be secured. Additionally or alternatively, the two-panel barrier assembly 144 can also be in a position anywhere along tracks 132 and 142. In other words, the fore-aft position of the single-panel barrier assembly 844 is customizable, based on the tracks 132 and tracks 838, and the fore-aft position of the two-panel barrier assembly 144 is customizable, based on the tracks 132 and the tracks 142. For instance, as depicted in the example embodiment illustrated in FIG. 10, the single-panel barrier assembly 844 can be secured in a first position 1002, a second position 1004, a third position 1006, or any other position along the tracks 132 and the tracks 838 that is between the terminal ends (e.g., a first terminal end 872 and a second terminal end 874, as illustrated in FIG. 8) or of the tracks 132 and the tracks 838, respectively.

With reference now to FIG. 11, a flow diagram is depicted that includes operations or steps in accordance with a method 1100 of the present disclosure. In addition, pictorials are provided in FIG. 11 in association with each of the operations or steps to help illustrate one or more examples related to this description, and the claims are not limited by the pictorials. In at least some examples, the method 1100 can include, at step 1102, pivoting, relative to a side wall of a cargo container and in a first direction, a panel (e.g., either semi-rigid or rigid) that is attached by a hinge to a track, which is attached to the side wall. For example, in association with a barrier assembly (e.g., either a two-panel or a single-panel barrier assembly), such as the two-panel barrier assembly 144, can be in a stowed position, as depicted at stage 1108, then the panels of the two-panel barrier assembly 144 (e.g., the first panel 102 and the second panel 104) can be pivoted away from the inner walls of the cargo carrier (e.g., the first side wall 112 and the second side wall 114), as depicted at stage 1110.

In at least some examples, the method 1100 can include, at step 1104, after the panel has been pivoted in the first direction by a threshold amount, which unlocks the hinge from the track, sliding the hinge along the track. For instance, the panels of the two-panel barrier assembly 144 can be pivoted by a threshold amount into a locked position (e.g., between 55 and 140 degrees relative to an inner side wall of the cargo container), wherein the hinge is locked into the tracks, as depicted in stage 1112, then the panels may be pivoted in the opposite direction by a threshold amount (e.g., less than 55 degrees or more than 140 degrees) to unlock the hinges, as depicted in stage 1114, allowing the hinges to slide along the tracks. Furthermore, in at least some examples, the method 1100 can include, at step 1106, pivoting, relative to the side wall of the cargo container and in a second direction opposite to the first direction, the panel to lock the hinge relative to the track. For example, moving the panels of two-panel barrier assembly 144 in the opposite direction of the first direction by a certain amount can put the panels in a position that is flush against the walls of the cargo container (e.g., the first side wall 112 and/or the second side wall 114), as depicted at stage 1116, wherein the two-panel barrier assembly 114 can be locked in a stowed position.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The present embodiments are described with reference to the drawings in which like elements are referred to by like numerals. The relationship and functioning of the various elements of this disclosure are better understood from the detailed description. However, the embodiments of the disclosure are not limited to the embodiments illustrated in the drawings. It should be understood that in certain instances, details have been omitted which are not necessary for an understanding of the present disclosure, such as conventional fabrication and assembly.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or examples can become apparent to those of ordinary skill in the art to which the present subject matter pertains without departing from the scope hereof.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

1. A barrier assembly configured to at least partially span an opening of a cargo compartment, the barrier assembly comprising:
a track configured to attach to a side wall of the cargo compartment, the track comprising a first terminal end and a second terminal end;
a hinge that is coupled to the track and that is operable to transit along the track and to releasably lock into any of a plurality of hinge positions between the first terminal end and the second terminal end;
a panel having a first side edge and a second side edge, which is opposite the first side edge;
the first side edge coupled to the hinge; and
the second side edge comprising a releasable fastener.

2. The barrier assembly of claim 1, wherein the track comprises a rail along which the hinge is slidable when transitioning among the plurality of hinge positions, and wherein the track comprises a series of recesses that extends between the first terminal end and the second terminal end and that engages the hinge to retain the hinge in a respective hinge position of the plurality of hinge positions.

3. The barrier assembly of claim 1, wherein:
the hinge comprises a hinge plate, which attaches to the panel, and a slider bracket, which slidably attaches to the rail; and
the hinge plate is, via a first knuckle, pivotably coupled to the slider bracket.

4. The barrier assembly of claim 3, wherein:
a pawl is pivotably coupled to the slider bracket and comprises a head configured to mate with any recess of the series of recesses; and
the first knuckle comprises a camming surface that, when the hinge plate pivots relative to the slider bracket, engages the pawl.

5. The barrier assembly of claim 4, wherein the hinge comprises a spring that biases the pawl, and wherein the camming surface engaging the pawl counteracts a force associated with the spring.

6. The barrier assembly of claim 4, wherein the hinge plate is co-planar with a first plane and the slider bracket is co-planar with a second plane, which intersects with the first plane at an angle; and wherein engagement of the camming surface with the pawl retains the head in a position disengaged from any of the recesses when the angle is between 55 degrees and 140 degrees.

7. The barrier assembly of claim 1, wherein the panel comprises a composite polymer material.

8. The barrier assembly of claim 1, wherein the releasable fastener comprises an adjustable-length strap.

9. The barrier assembly of claim 8, wherein the strap comprises one of a male connector or a female connector.

10. The barrier assembly of claim 1, wherein the barrier assembly comprises an anchor that is attachable to the side wall, and wherein the releasable fastener is attachable to the anchor.

11. The barrier assembly of claim 1, wherein the releasable fastener is attachable to a second panel.

12. The barrier assembly of claim 1, wherein the releasable fastener is attachable to an opposing wall that is opposite the side wall.

13. A cargo compartment comprising:
a first side wall;
a second side wall that is opposite the first side wall and is spaced apart from the first side wall by a distance; and
a barrier assembly configured to at least partially span the distance, the barrier assembly comprising:
a track configured to attach to the first side wall of the cargo compartment, the track comprising a first terminal end and a second terminal end;
a hinge that is coupled to the track and that is operable to transit along the track and to selectively lock into any of a plurality of hinge positions between the first terminal end and the second terminal end;
a panel having a first side edge and a second side edge, which is opposite the first side edge;
the first side edge coupled to the hinge; and
the second side edge comprising a releasable fastener.

14. The cargo compartment of claim 13, wherein the track comprises a rail along which the hinge is slidable when transitioning among the plurality of hinge positions, and wherein the track comprises a series of recesses that extends between the first terminal end and the second terminal end and that engages the hinge to retain the hinge in a respective hinge position of the plurality of hinge positions.

15. The cargo compartment of claim 13, wherein:
the hinge comprises a hinge plate, which attaches to the panel, and a slider bracket, which slidably attaches to the rail; and
the hinge plate is, via a first knuckle, pivotably coupled to the slider bracket.

16. The cargo compartment of claim 15, wherein:
a pawl is pivotably coupled to the slider bracket and comprises a head configured to mate with any recess of the series of recesses; and
the first knuckle comprises a camming surface that, when the hinge plate pivots relative to the slider bracket, engages the pawl.

17. The cargo compartment of claim 16, wherein the hinge comprises a spring that biases the pawl, and wherein the camming surface engaging the pawl counteracts a force associated with the spring.

18. The cargo compartment of claim 16, wherein the hinge plate is co-planar with a first plane and the slider bracket is co-planar with a second plane, which intersects with the first plane at an angle; and wherein engagement of the camming surface with the pawl retains the head in a position disengaged from any of the recesses when the angle is between 55 degrees and 140 degrees.

19. The cargo compartment of claim 13, wherein the releasable fastener comprises an adjustable-length strap.

20. A method comprising:
pivoting, relative to a side wall of a cargo container and in a first direction, a panel that is attached by a hinge to a track, which is attached to the side wall;
after the panel has been pivoted in the first direction by a threshold amount, which unlocks the hinge from the track, sliding the hinge along the track; and
pivoting, relative to the side wall of the cargo container and in a second direction opposite to the first direction, the panel to lock the hinge relative to the track.
